(19) United States
(12) Patent Application Publication
(10) Pub. No.: US 2019/0068384 A1
(43) Pub. Date: Feb. 28, 2019

(54) AUTHENTICATION SYSTEM OF SYNCHRONIZING REAL-TIME MULTI-DIMENSIONS TIMESTAMP ISSUED BY A MULTI-DIMENSIONS TIMESTAMP DEVICE AND A METHOD THEREOF

(71) Applicant: NOBUYOSHI MORIMOTO, Taipei City (TW)

(72) Inventor: NOBUYOSHI MORIMOTO, Taipei City (TW)

(21) Appl. No.: 16/171,152

(22) Filed: Oct. 25, 2018

Related U.S. Application Data
(63) Continuation-in-part of application No. 14/983,714, filed on Dec. 30, 2015, now Pat. No. 10,146,252.

(30) Foreign Application Priority Data
Dec. 31, 2014 (TW) 103146701

(51) Int. Cl. H04L 9/32; G06F 15/173; G06F 1/14; G06F 17/30; H04L 29/08

(52) U.S. Cl. CPC H04L 9/3297; G06F 15/17325; H04L 67/18; G06F 17/30241; G06F 1/14

(57) ABSTRACT

The present invention is related to an authentication system of synchronizing real-time multi-dimensions timestamp issued by a multi-dimensions timestamp device and a method thereof. The multi-dimensions timestamp device provides a real-time machine time, and the provider end uses the multi-dimensions timestamp device to implant a real-time multi-dimensions timestamp into a digital content. Meanwhile, a multi-dimensions geographic information provider provides a multi-dimensions geographic information to the provider end, and the provider end provides a network location information, and incorporates the digital content, the real-time multi-dimensions timestamp, the multi-dimensions geographic information, and the network location information together as a reliable digital content. The receiver end can retrieve the reliable digital content from an arbitrary party end or connect to the provider end to confirm whether the reliable digital content has the identical real-time multi-dimensions timestamp and the multi-dimensions geographic information to ensure the authenticity of the received reliable digital content.

### REFERENCE TO RELATED APPLICATIONS

The present application is based on, and claims priority from, U.S. patent application Ser. No. 14/983,714, filed Dec. 30, 2015, the disclosure of which is hereby incorporated by reference herein in its part.

### BACKGROUND OF THE INVENTION

### 1. Field of the Invention

The present invention is related to an authentication system of synchronizing real-time multi-dimensions timestamp issued by a multi-dimensions timestamp device and a method thereof.

### 2. Description of the Prior Art

Previously, for verifying the authenticity of a signature or a stamp on a paper document, or the paper document truly exists at a specific time, an unbiased third party unit is required, such as a notarization from the court or an attorney, to confirm the existence of the paper document and the authenticity of the signature or stamp.

Recently, regarding that more people or company using personal computer to produce electric documents, the demand of requesting a third party electrical authentication to authenticate the producing time and the content of digital information therefore increases as well.

As aforementioned, many third electric authentication institutes published corresponding techniques for electric authentication service. These electric authentication services are used to ensure the un-deniability of an electric document. For example, such as the technologies request the provider end of the electric document to stamp an electric stamp on the electric document or stamp a reliable digital timestamp on an electric document with digital signature. The digital timestamp is configured to combine a reliable date and time with the electric document, which is very common in electric business trade.

In the prior art of reference of China published application No. CN 103281292A, it disclosed several embodiments of digital timestamp applications:
1. Online bid to ensure accurate bidding sequence of priority;
2. Electric vote to ensure the voting is only validated within a promised time period;
3. Publishing to ensure the text is published within a given time period;
4. Online gambling to ensure the bet is made before the event; and
5. Digital copyright management to ensure a certain content is accessible when it is permitted.

Among aforementioned applications, the common issue is that the consistency of machine time of an ideal digital timestamp. For an ideal digital timestamp mechanism, the accurate machine time is the most essential element in the verification. If the machine time of a digital timestamp of the electric document is simply provided by the provider end, since the machine time of a single machine is easily to be modified, the accuracy and the safety of the machine time is hard to be ensured. Besides, when the electric document or the electric trade process requires multiple digital timestamps from several parties, the difference or corrected difference of the machine time among these digital timestamps of these provider ends would be a potential problem seriously influencing the time verification accuracy of the digital timestamp.

To solve aforementioned problem of different machine times, some prior arts provide a plurality of solutions aiming on the machine time consistency issue. For example, the Network Time Protocol, NTP, is a protocol developed to provide a reliable time for single events. It allows different parties can evaluate the simultaneity of an event or time difference among different events. However, NTP is not capable of providing time approval and time indication.

The Wikipedia webpage of the title of “trusted timestamping” (http://en.wikipedia.org/wiki/Trusted_timestamping) describes several different solutions based on timestamp machine. But these solutions all rely on trusted authentication organizations or parties for providing timestamps.

In the one of the figures on that Wikipedia webpage, it describes that a provider end first proceeds an electric document by calculating hashes to generate a provider end hash information, and then sends the information to the trusted third party for electric authentication. The trusted third party adding a digital timestamp onto the provider end hash information and calculating the hashes again to generate the authentication end hash information. The authentication end hash information then is provided with a private key for encryption to generate an encrypted timestamp information. Then the encrypted timestamp information and the digital timestamp are transmitted back to the provider end simultaneously. The provider end then incorporates the electric document, the encrypted timestamp information, and digital timestamp together as a reliable timestamp electric document.

When a document receiver end retrieves the reliable timestamp electric document, and is demanded to prove the authenticity of the reliable timestamp electric document, it proceeds the electric document with the same hash calculating process done by the provider end to generate a receiver end hash information. The receiver end hash is then proceeded with the digital timestamp by calculating the same hash calculating process done by the trusted third party to generate a to-be-compared hash information. The encrypted timestamp information is decrypted by a public key to obtain the authentication end hash information. Then the to-be-compared hash information is compared with the authentication end hash information. If they are consistent, then the authentication passes, which means the reliable timestamp electric document received by the document receiver end is reliable, otherwise, the reliable timestamp electric document received by the document receiver end is not reliable.

As aforementioned description, the previous technologies of stamping digital timestamp on the electric document come with several disadvantages. It requires a reliable third party electric authentication providing reliable time and service of stamping authentication timestamp. And the third party electric authentication has to provide specific hash calculating procedure and verification service, such as Public Key Infrastructure technique, and these limitations make the technology more and more complex in stamping digital timestamp on the electric document. And, if the third party electric authentication fails in security, such as being attacked by hackers or backdoor programs, the security of authentication would be questioned as well, which would cause the whole authentication mechanism to lose its credibility and reliability.

Furthermore, when the provider end (location A) and the document receiver (location B) are right at different locations in the same GMT time zone, as shown in FIG. 1, the machine time which in the reliable timestamp from the provider end would be same with the time of the location of the document receiver.

Thus, to develop a simple, safer, and accurate system and method thereof for stamping digital timestamp on the electric document and verifying digital timestamp can be considered as an urgent issue.

### SUMMARY OF THE INVENTION

As aforementioned, the conventional technologies face credibility and reliability issues in third party electric authentication providing service of authenticating digital content. One objective of the present invention is to ensure the provider end using a multi-dimensions timestamp device to implant a having undeniable real-time multi-dimensions timestamp into the digital content and transmitting it to a receiver end without an intermediate third party calculating hashes and processing authentication. Another objective of the present invention is to ensure the receiver end getting authentication information from provider end after the electric document from the provider end is received by the receiver end and the authenticity of the electric document can be verified without using any third party authentication information.

One objective of the present invention is to provide a system for implanting a synchronizing real-time multi-dimensions timestamp into a digital content by a multi-dimensions timestamp device. It comprises a multi-dimensions timestamp device and a provider end. The multi-dimensions timestamp device is configured to provide a real-time machine time accurately, wherein the real-time machine time is accurate to the minimum time unit that the multi-dimensions timestamp device can present. The provider end is configured to use the multi-dimensions timestamp device to implant a real-time multi-dimensions timestamp into a digital content, a multi-dimensions geographic information provider provides a multi-dimensions geographic information to the provider end, and the provider end incorporates the digital content, the real-time multi-dimensions timestamp, and the multi-dimensions geographic information together as a reliable digital content.

One objective of the present invention is to provide a method for implanting a synchronizing real-time multi-dimensions timestamp into a digital content by a multi-dimensions timestamp device, the method is applied between a multi-dimensions timestamp device and a provider end and the method comprising steps as follows: the provider end provides a digital content; the provider end requests a timestamp request to the multi-dimensions timestamp device for implanting a real-time multi-dimensions timestamp into the digital content; the multi-dimensions timestamp device responds to the timestamp request and provides the real-time multi-dimensions timestamp to the provider end; a multi-dimensions geographic information provider provides a multi-dimensions geographic information to the provider end; the provider end incorporates the digital content, the real-time multi-dimensions timestamp, and the multi-dimensions geographic information together as a reliable digital content.

Another objective of the present invention is to provide an authentication system of synchronizing real-time multi-dimensions timestamp issued by a multi-dimensions timestamp device. The authentication system comprises a multi-dimensions timestamp device, a provider end, and a receiver end. The multi-dimensions timestamp device is configured to provide a real-time machine time, wherein the real-time machine time is accurate to the minimum time unit that the multi-dimensions timestamp device can present. The provider end is configured to use the multi-dimensions timestamp device to implant a real-time multi-dimensions timestamp into a digital content. A multi-dimensions geographic information provider provides a multi-dimensions geographic information to the provider end, the provider end further provides a network location and incorporates the digital content, the real-time multi-dimensions timestamp, the network location information, and the multi-dimensions geographic information together as a reliable digital content. The receiver end is configured to receive the reliable digital content from an arbitrary party end, wherein the receiver end retrieves the real-time multi-dimensions timestamp, the network location information, and the multi-dimensions geographic information from the reliable digital content. And the receiver end is connected to the provider end via network according to the network location information to confirm whether the provider end has the consistent reliable digital content, when the received reliable digital content in the receiver end is confirmed to have the same reliable digital content, the receiver end confirms whether the reliable digital content from the arbitrary party end has the consistent real-time multi-dimensions timestamp, and the multi-dimensions geographic information, then the receiver end confirms the reliable digital content which is received by the receiver end being genuine after the real-time multi-dimensions timestamp and the multi-dimensions geographic information are confirmed the consistent with the reliable digital content of the provider end.

Another objective of the present invention is to provide an authentication method of synchronizing real-time multi-dimensions timestamp issued by a multi-dimensions timestamp device, the method is applied among a multi-dimensions timestamp device, a provider end, and a receiver end which comprising following steps: the provider end provides a digital content; the provider end requests a timestamp request to the multi-dimensions timestamp device for implanting a real-time multi-dimensions timestamp into the digital content; the multi-dimensions timestamp device responds to the timestamp request and provides the real-time multi-dimensions timestamp to the provider end; a multi-dimensions geographic information provider provides a multi-dimensions geographic information to the provider end, the provider end provides a network location; and the provider end incorporates the digital content, the real-time multi-dimensions timestamp, the network location information, and the multi-dimensions geographic information together as a reliable digital content; the receiver end retrieves the reliable digital content from an arbitrary party end; the receiver end retrieves the real-time multi-dimensions timestamp, the network location information, and the multi-dimensions geographic information, when the receiver end issues a verification request; the receiver end is connected to the provider end via the network according to the network location information; the receiver end confirms the consistency of the reliable digital content to the provider end; the receiver end confirms whether the reliable digital content from the provider end has the consistent real-time multi-dimensions timestamp and the multi-dimensions geographic information, when the receiver end confirms that the provider end has the same reliable digital content; then the receiver end confirms whether the received reliable digital content has the consistent real-time multi-dimensions timestamp, and the multi-dimensions geographic information, after the receiver end confirms that the reliable digital content of the provider end has the same real-time multi-dimensions timestamp, and the multi-dimensions geographic information, the receiver end verifies whether the reliable digital content matches with a verifying information, if the verification is positive, then the receiver end confirms the reliable digital content which is received by the receiver end being genuine.

### BRIEF DESCRIPTION OF THE DRAWINGS

The techniques of present invention would be more understandable from the detailed description given herein below and the accompanying figures are provided for better illustration, and thus description and figures are not limitative for present invention, and wherein:

FIG. 1 shows the schematic diagram of two different locations in GMT time zone of the prior art;

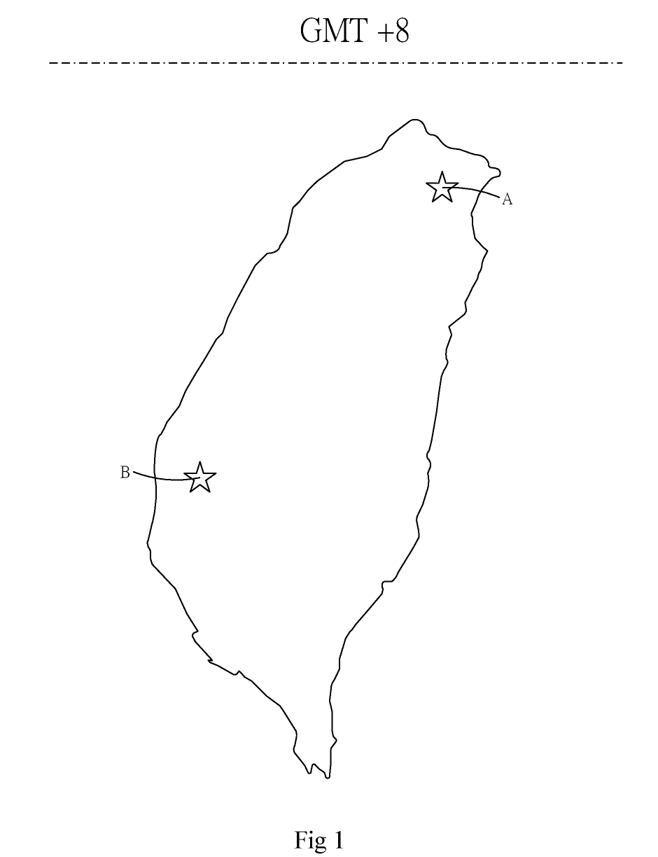

FIG. 2 shows the system component diagram of implanting synchronizing real-time multi-dimensions timestamp of the present invention;

FIG. 3 shows the flow diagram of the method of implanting synchronizing real-time multi-dimensions timestamp in the digital content of the present invention;

FIG. 4 shows the components of the authentication system of the present invention;

FIG. 5 shows the flow diagram of the authentication method of the present invention; and

FIG. 6 shows the flow diagram of another authentication method of the present invention.

### DETAILED DESCRIPTION OF THE PREFERRED EMBODIMENT

To clearly show the objectives, technologies, and features of the present invention, please find some preferred embodiments and figures regarding details of the present invention below. It should be noted that the embodiments are provided for further explaining but not limiting present invention.

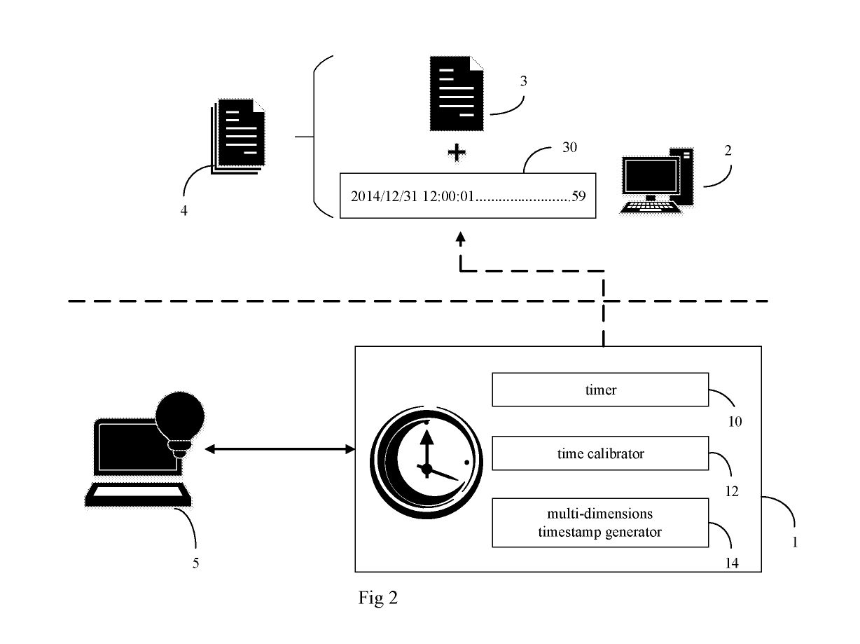

FIG. 2 shows the components of the system for implanting a synchronizing real-time multi-dimensions timestamp on a digital content by a multi-dimensions timestamp device. It comprises a multi-dimensions timestamp device 1 and a provider end 2. The multi-dimensions timestamp device 1 is configured to provide a real-time machine time 10, wherein the real-time machine time 10 is accurate to the minimum time unit that the multi-dimensions timestamp device 1 can present. Generally speaking, the minimum time unit provided by the multi-dimensions timestamp device 1 is related to the data process bits of the operating system, OS, or application programs installed in the machine. The provider end 2 is configured to use the multi-dimensions timestamp device 1 to implant the real-time multi-dimensions timestamp 30 into a digital content 3 and incorporate the digital content 3, the real-time multi-dimensions timestamp 30 together as a reliable digital content 4.

Regarding to the present invention, the multi-dimensions timestamp device 1 can be a hardware or software. The multi-dimensions timestamp device 1 at least comprises a timer 10, a time calibrator 12, and a multi-dimensions timestamp generator 14. The timer 10 is configured to output a time. The time calibrator 12 is connected to the timer 10 and a coordinated time provider 5, wherein the coordinated time provider 5 provides a coordinated time, and the time calibrator 12 retrieves the coordinated time from the coordinated time provider 5 and applies a time calibration algorithm to calibrate the coordinated time as a solar time, and provides the solar time to the timer 10 as the correct time. The multi-dimensions timestamp generator 14 is connected to the timer 10, and after the multi-dimensions timestamp generator 14 is activated, it applies the present time of the timer 10 as the real-time machine time and implanting into the digital content 3.

Regarding to the present invention, the multi-dimensions timestamp device 1 confirming a response time difference between several multi-dimensions timestamp devices 1 located in different solar time areas via the coordinated time provider 5 and calibrating the coordinated time as the solar time according to the coordinated time of the coordinated time provider 5 and the response time difference. Moreover, the solar time can be calculated into 10⁻¹⁸ s (A second) for providing more accurate time.

Regarding to the present invention, the multi-dimensions timestamp device 1 can be a wearable electric device or an implantable timer. Wherein, the wearable electric device can be a smart watch, smart glasses or a smart necklace, and other devices refer to the mobile devices contact to the human body directly or indirectly. Which means the provider end 2 can be a computer, a tablet, a multimedia device or smart phone which is able to be connected to network. The multi-dimensions timestamp device 1 refers to the application programs installed in the aforementioned computer, tablet, multimedia device or smart phone. Thus, the provider end 2 can provide real-time machine time from a built-in multi-dimensions timestamp device 1 or an external timestamp device 1.

Regarding to the present invention, the real-time multi-dimensions timestamp 30 which is provided by the multi-dimensions timestamp device 1 could further include longitude, latitude, or both, due to the solar time has to be calculated according to the accurate location; and the real-time machine time (the solar time) can also be the real-time multi-dimensions timestamp 30 if the real-time multi-dimensions timestamp 30 is only consisted by the real-time machine time.

Regarding to the present invention, the provider end 2 applies the multi-dimensions timestamp device 1 to implant the real-time multi-dimensions timestamp 30 into the digital content 3, and a multi-dimensions geographic information provider provides a multi-dimensions geographic information to the provider end 2, such as longitude, latitude and altitude coordinate values provided by the multi-dimensions geographic information provider (such as through Global Positioning System (GPS) to provide the longitude, latitude and altitude, or the principle of triangulation or an altimeter to provide the altitude) for strengthen the reliability of the system. Moreover, for protecting the privacy of the provider end 2, the multi-dimensions geographic information provider which can be installed in the provider end 2 or the multi-dimensions timestamp device 1, or the multi-dimensions geographic information provider can also be an external independent device to provide the multi-dimensions geographic information as well.

Regarding to the present invention, to provide service of remote authentication to the reliable digital content 4 in network, the provider end 2 applies the multi-dimensions timestamp device 1 to implant the real-time multi-dimensions timestamp 30 into the digital content 3, and the provider end 2 further provides the network location information 34 for tracking the provider end 2. The network location information can be such as the Internet Protocol Address (IP address), Domain Name, or Media Access Control Address (MAC).

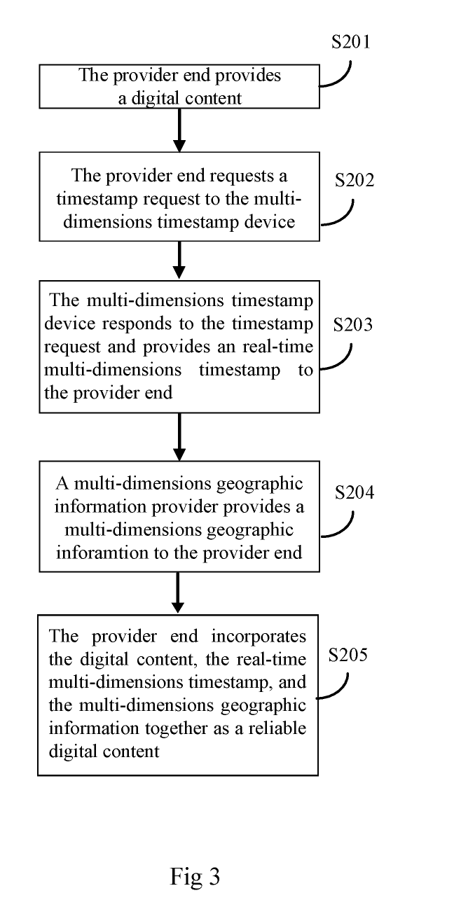

FIG. 3 shows the flow diagram of the method for implanting a synchronizing real-time multi-dimensions timestamp on a digital content by a multi-dimensions timestamp device. The method is applied between a multi-dimensions timestamp device and a provider end and comprises steps as follows:
(S201) the provider end providing a digital content;
(S202) the provider end requesting a timestamp request to the multi-dimensions timestamp device for implanting a real-time multi-dimensions timestamp into the digital content;
(S203) the multi-dimensions timestamp device responding for the timestamp request and providing the real-time multi-dimensions timestamp to the provider end;
(S204) a multi-dimensions geographic information provider providing a multi-dimensions geographic information to the provider end; and
(S205) the provider end incorporating the digital content, the real-time multi-dimensions timestamp, and the multi-dimensions geographic information together as a reliable digital content.

In a first embodiment of the present invention, the provider end can be a computer, a tablet, a multimedia device or smart phone which is able to be connected to network. In this embodiment, it takes computer as an example for further explanation. And the digital content can be a digital multimedia file, a digital audio file, a digital document, etc. In this embodiment, the PDF (Portable Document Format) format is taken as an example for further explanation. The multi-dimensions timestamp device can be a wearable electric device or an implantable timer, and the wearable electric device can be a smart watch, smart glasses. In this embodiment, a smart watch is chosen for further explanation. When a user finishes a PDF by a computer, the user operates the computer to send out a timestamp request to the smart watch, then the smart watch provides a real-time multi-dimensions timestamp to the computer. After that, the multi-dimensions geographic information provider which is installed in the computer further provides the multi-dimensions geographic information to the computer, and the computer incorporates the digital content, the real-time multi-dimensions timestamp, and the multi-dimensions geographic information together as a reliable digital content. The computer and the smart watch can be connected to each other through infrared ray, Bluetooth, or Wi-Fi, preferably infrared ray or Bluetooth.

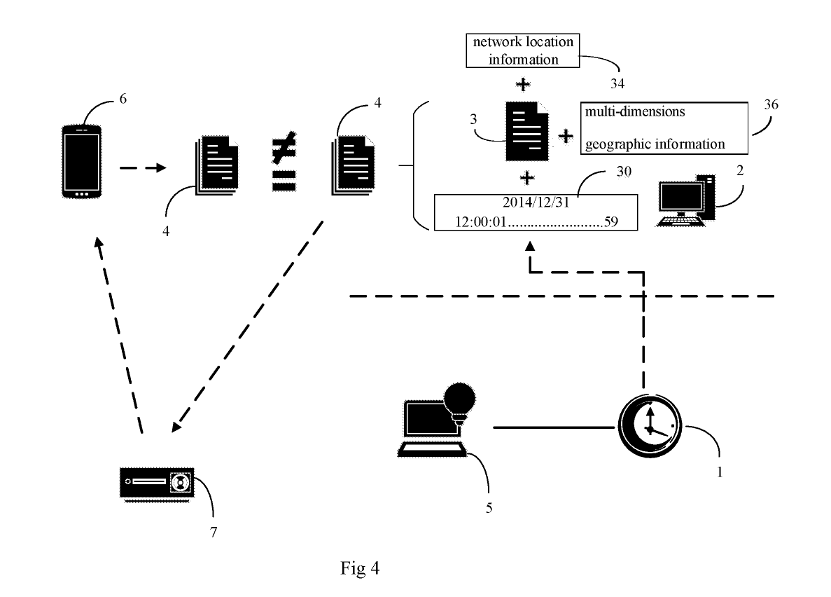

FIG. 4 shows an authentication system of synchronizing real-time multi-dimensions timestamp issued by a multi-dimensions timestamp device 1 of the present invention, which is generally similar to the previous system for implanting a synchronizing real-time multi-dimensions timestamp in a digital content 3 by a multi-dimensions timestamp device 1. The difference is that the authentication system further comprises a receiver end 6, and a provider end 2 is configured to use the multi-dimensions timestamp device 1 for implanting the real-time multi-dimensions timestamp 30 into a digital content 3, and a multi-dimensions geographic information provider provides a multi-dimensions geographic information 36 to the provider end 2, and the provider end 2 provides a network location information 34, and incorporates the digital content 3, the real-time multi-dimensions timestamp 30, the network location information 34, and the multi-dimensions geographic information 36 together as a reliable digital content 4. The receiver end 6 is configured to receive the reliable digital content 4 from an arbitrary party end 7, wherein the receiver end 6 retrieves the real-time multi-dimensions timestamp 30, the network location information 34, and the multi-dimensions geographic information 36 from the reliable digital content 4, and is connected to the provider end 2 via network according to the network location information 34 to confirm whether the provider end 2 has the same reliable digital content 4, when the received reliable digital content 4 in the receiver end 6 is confirmed to have the same reliable digital content 4, then to check whether the real-time multi-dimensions timestamp 30, and the multi-dimensions geographic information 36 received by the receiver end 6 is the same. If the consistency is confirmed, then the reliable digital content 4 from the arbitrary party end 7 is genuine.

Regarding to the present invention, the provider end 2 applies the multi-dimensions timestamp device 1 to implant the real-time multi-dimensions timestamp 30 into the digital content 3, and the provider end 2 provides bio-feature information (such as voice of the user, fingerprint, or DNA from the provider end 2), and the digital content 3, the real-time multi-dimensions timestamp 30, the network location information 34, the multi-dimensions geographic information 36, and the bio-feature information together are incorporated as a reliable digital content 4 to enhance the reliability or un-deniability of the reliable digital content 4. Thus, even another person pirates the digital content 3, the real-time multi-dimensions timestamp 30, the network location information 34, and the multi-dimensions geographic information 36 of the provider end 2, but the person does not have the bio-feature from provider end 2, the person would not be capable of producing the identical reliable digital content 4.

Regarding to the present invention, when the reliable digital content 4 received by the receiver end 6 is considered as not genuine, the receiver end 6 can transmit a warning message to the provider end 2 according to the network location information 34 to inform the provider end 2 that the electric document might has been pirated or attacked by hackers.

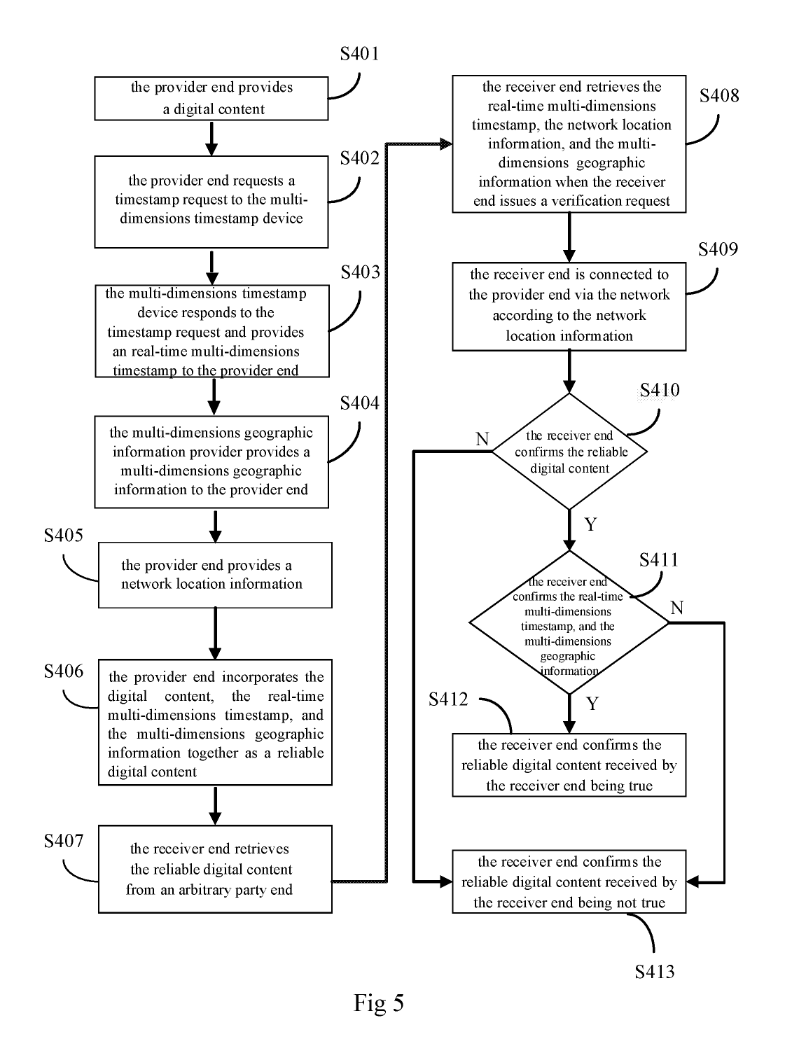

FIG. 5 shows the flow diagram of the authentication method of synchronizing real-time multi-dimensions timestamp issued by a multi-dimensions timestamp device of the present invention. The method is applied among a multi-dimensions timestamp device, a provider end, and a receiver end, which comprises steps as follows:
(S401) the provider end providing a digital content;
(S402) the provider end requesting a timestamp request to the multi-dimensions timestamp device for implanting a real-time multi-dimensions timestamp into the digital content;
(S403) the multi-dimensions timestamp device responding for the timestamp request and providing a real-time multi-dimensions timestamp to the provider end;
(S404) a multi-dimensions geographic information provider providing a multi-dimensions geographic information to the provider end;
(S405) the provider end providing a network location information;
(S406) the provider end incorporating the digital content, the real-time multi-dimensions timestamp, the network location information, and the multi-dimensions geographic information together as a reliable digital content;
(S407) the receiver end retrieving the reliable digital content from an arbitrary party end;
(S408) the receiver end retrieving the real-time multi-dimensions timestamp, the network location information, and the multi-dimensions geographic information when the receiver end issues a verification request;
(S409) the receiver end being connected to the provider end via the network according to the network location information;
(S410) the receiver end confirming whether the identical reliable digital content exists in the provider end, wherein if the confirmation is positive, then step
(S411) is executed, otherwise step (S413) is executed;
(S411) the receiver end confirming whether the reliable digital content from the provider end has the identical real-time multi-dimensions timestamp and the multi-dimensions geographic information, wherein if the confirmation is positive, then step (S412) is executed, otherwise step (S413) is executed;
(S412) the receiver end confirming the reliable digital content received by the receiver end being genuine; and
(S413) the receiver end confirming the reliable digital content received by the receiver end being not genuine.

In a second embodiment of the present invention is similar to last embodiment, wherein the difference is that the receiver end is a device such as a computer, a tablet, a multimedia device, or a smart phone which is able to connect to the network. In the present embodiment, it takes computer and smart phone as the receiver end for further exemplary explanation. Also, it takes PDF as the digital content for further explanation. In the present embodiment, the multi-dimensions timestamp device is an application program installed in the computer.

In this embodiment, when a user finishes a PDF by a computer, the user operates the computer to send out a timestamp request to the program installed in the computer, then the program installed in the computer provides a real-time multi-dimensions timestamp to the computer, in the meantime, the multi-dimensions geographic information provider which is installed in the computer further provides a multi-dimensions geographic information to the computer, and the computer further provides a network location information. After that, the computer incorporates the digital content, the real-time multi-dimensions timestamp, and the network location information together as a reliable digital content. Then the smart phone retrieves the reliable digital content from the memory card or email provided by the arbitrary party. The smart phone is able to retrieve the network location information, such as IP address, for the smart phone to connect to the computer via network. Thus the smart phone is able to confirm whether the computer has the same reliable digital content. Then the smart phone confirms that if the computer has the identical reliable digital content. Once the identical reliable digital content of the computer is confirmed to have the same real-time multi-dimensions timestamp and the multi-dimensions geographic information, it can be sure that the reliable digital content received by the smart phone is genuine. But if any of the reliable digital content, the real-time multi-dimensions timestamp, and the multi-dimensions geographic information is confirmed to be not identical to the one reserved in the computer, the reliable digital content received by the smart phone is therefore confirmed to be not genuine.

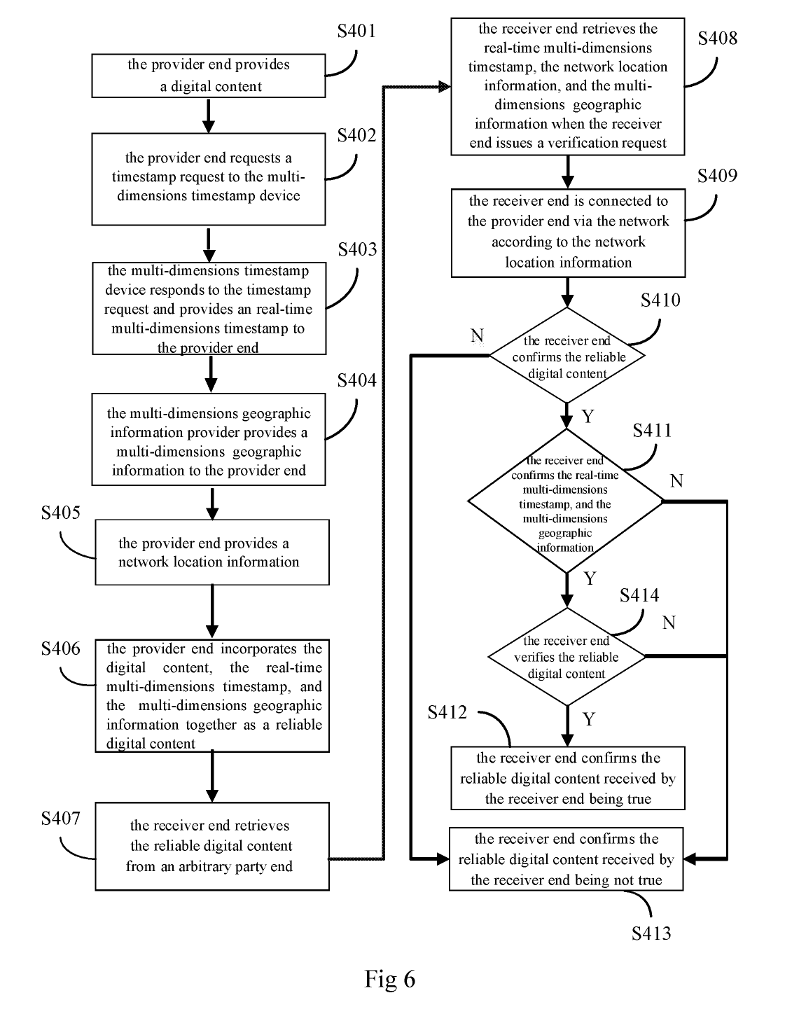

FIG. 6 shows the flow diagram of another authentication method of synchronizing real-time multi-dimensions timestamp issued by a multi-dimensions timestamp device of the present invention. The method is applied among a multi-dimensions timestamp device, a provider end, and a receiver end.

In a third embodiment of the present invention is similar to the second embodiment, the difference between the second embodiment and the third embodiment is that the third embodiment further provides (S414) the receiver end verifying whether the reliable digital content matches with a verifying information, wherein if the verification is positive, then step (S412) is executed, otherwise step (S413) is executed. In the present embodiment, the reliable digital content can be used in security filed. For example, when an user is patrolling to some specific points and arriving at one of specific points, the user can use a smart phone (the provider end) to connect with the smart watch (the multi-dimensions timestamp device), the smart phone generates a signing information (the digital content), and sends a timestamp request to the smart watch through the smart phone, then the smart watch provides the real-time multi-dimensions timestamp to the smart phone, at mean time, the multi-dimensions geographic information provider which installed in the smart watch or the smart phone further provides the multi-dimensions geographic information to the smart phone. After that, the smart phone incorporates the multi-dimensions geographic information, the real-time multi-dimensions timestamp, and the signing information together as a reliable digital content. Specifically, assuming the signing information is a serial number, when the real-time multi-dimensions timestamp implants into the signing information, the real-time multi-dimensions timestamp will be incorporated into the serial number, for example the original serial number is 70450232177, after the real-time multi-dimensions timestamp implants into the signing information, the serial number is incorporated with the real-time multi-dimensions timestamp by a hashing algorithm and became 3223563145704502B0ahJlxthFn353325632177 or other forms, moreover, if the serial number (the signing information) and the real-time multi-dimensions timestamp are further incorporated with the multi-dimensions geographic information by the hashing algorithm, it might become 3223 . . . 33256324o.4z3th8t.1s4z31779p5. Therefore, the real-time multi-dimensions timestamp, the multi-dimensions geographic information, and the signing information can be incorporated together as the reliable digital content by the smart phone.

The arbitrary party end (including the smart phone) sends the reliable digital content to a security equipment (the receiver end) when the reliable digital content is generated, the security equipment starts retrieving and verifying whether the reliable digital content exists and matches with a verifying information which is set in the security equipment. In detail, the verifying information might include a location (including longitude, latitude, altitude), a time limitation, and a personal information, when the reliable digital content sends to the security equipment, the security equipment starts retrieving the reliable digital content, and it would become 3223563145704502201807161435332563241.403382.164031779.5 or other forms, wherein the number of 3223563145 is a IP address of device, 704502 can be a company number, 20180716143533256 is the real-time machine time (2018 year, 07 month, 16 day, 14 hour, 35 minute, 33 second, 256 millisecond (the real-time machine time is calculated into millisecond as an example herein)) in the real-time multi-dimensions timestamp, 32 can be a department number, 41.40338 is the latitude, 2.16403 is the longitude, 177 can be an employee number, and 9.5 (meter) is the altitude. Then the security equipment verifies the reliable digital content through connecting with the smart phone (through the IP address) to confirm whether the reliable digital content exists, and confirm whether the real-time multi-dimensions timestamp and the multi-dimensions geographic information in the reliable digital content match the real-time multi-dimensions timestamp and the multi-dimensions geographic information in the smart phone, and verifying whether the reliable digital content matches with the verifying information if the reliable digital content exists and matches with the real-time multi-dimensions timestamp and the multi-dimensions geographic information in the smart phone, when the reliable digital content matches with the verifying information, the security equipment confirms that the reliable digital content from the smart phone is true.

Furthermore, the reliable digital content can also be used in an autonomous car, when the provider end (such as a control center) generates the reliable digital content, then transmits to the autonomous car (the receiver end), the autonomous car starts verifying whether the reliable digital content reliable through connecting with the provider end to confirm whether the reliable digital content exists and matches, and verify whether the reliable digital content matches with the verifying information. Confirming the reliable digital content which received by the receiver end whether being genuine thereby.

As aforementioned, the present invention is able to transform the digital content into reliable digital content without the aid of a third party electric authentication service. The authenticity of the reliable digital content can be examined by the receiver end and the provider end without third party electric authentication service. The present invention provides a simple, safe, accurate, and efficient system and method for examining the truth of digital content. According to the embodiments, the multi-dimensions timestamp device can be flexible as a built-in OS or an external smart watch. Besides, the external multi-dimensions timestamp device and the built-in OS in the provider end can operate time synchronization.

In the other hand, the aforementioned of the digital content and the reliable digital content can also be send to the multi-dimensions timestamp device for saving the digital content and the reliable digital content. For example, after the provider end provides the digital content and sends the timestamp request to the multi-dimensions timestamp device, the provider can also send the digital content to the multi-dimensions timestamp device for saving the digital content and implanting the real-time multi-dimensions timestamp to the digital content, to avoid the provider end occurring the situation of data irretrievable hereby.

The aforementioned descriptions are provided for explaining the preferred embodiment of the present invention but not for limiting the present invention, and all other equivalent embodiments or modification within the scope of the present invention shall be deemed as covered by the claims of the present invention.

What is claimed is:

1. An authentication system of synchronizing real-time multi-dimensions timestamp issued by a multi-dimensions timestamp device, comprising:
a multi-dimensions timestamp device being configured to provide a real-time machine time as a real-time multi-dimensions timestamp, wherein the real-time machine time is accurate to the minimum time unit the multi-dimensions timestamp device can display; and
a provider end being configured to control the multi-dimensions timestamp device to implant the real-time multi-dimensions timestamp into a digital content, the provider end receives a multi-dimensions geographic information from a multi-dimensions geographic information provider and incorporates the digital content, the real-time multi-dimensions timestamp, and the multi-dimensions geographic information together as a reliable digital content.

2. The system as claimed in claim 1, wherein the multi-dimensions timestamp device at least comprises:
a timer being configured to output a time;
a time calibrator being connected to the timer and a coordinated time provider, wherein the coordinated time provider provides a coordinated time, and the time calibrator retrieves the coordinated time from the coordinated time provider and applies a time calibration algorithm to calibrate the coordinated time as a solar time, and provides the solar time to the timer for time calibration; and
a multi-dimensions timestamp generator, wherein the multi-dimensions timestamp generator is connected to the timer, and after the multi-dimensions timestamp generator is activated, the multi-dimensions timestamp generator applies the present time of the timer as the real-time machine time to be implanted into the digital content.

3. The system as claimed in claim 2, wherein when the time calibration algorithm of the timer calibrator of the multi-dimensions timestamp device is configured to ensure the multi-dimensions timestamp device confirming a response time difference between multiple multi-dimensions timestamp devices located in different solar time areas via the coordinated time provider, and calibrate the coordinated time as the solar time according to the coordinated time of the coordinated time provider and the response time difference.

4. The system as claimed in claim 1, wherein the multi-dimensions timestamp device is a program installed in one of a computer, a tablet, a multimedia device, or a smart phone, the multi-dimensions timestamp device is a wearable electric device or an implantable timer.

5. The system as claimed in claim 1, wherein the multi-dimensions geographic information provider is configured in the provider end or the multi-dimensions timestamp device, or the multi-dimensions geographic information provider is an external independent device to provide the multi-dimensions geographic information to the provider end.

6. The system as claimed in claim 5, wherein the multi-dimensions geographic information comprises at least one or the combination above two of a latitude, a longitude, or an altitude.

7. The system as claimed in claim 1, wherein the provider end further provides a network location information for tracking the provider end, and incorporates the digital content, the real-time multi-dimensions timestamp, the multi-dimensions geographic information, and the network location information together as a reliable digital content.

8. The system as claimed in claim 7, wherein the provider end further provides a bio-feature information, and incorporates the digital content, the real-time multi-dimensions timestamp, the network location information, and the bio-feature information together as a reliable digital content.

9. The system as claimed in claim 7, wherein the real-time multi-dimensions timestamp further includes longitude, latitude, or both.

10. An authentication method of synchronizing real-time multi-dimensions timestamp issued by a multi-dimensions timestamp device, the method is applied between a multi-dimensions timestamp device and a provider end and comprising steps of:
the provider end providing a digital content;
the provider end requesting a timestamp request to the multi-dimensions timestamp device for implanting a real-time multi-dimensions timestamp into the digital content;
the multi-dimensions timestamp device responding to the timestamp request and to provide the real-time multi-dimensions timestamp to the provider end;
a multi-dimensions geographic information provider providing a multi-dimensions geographic information to the provider end; and
the provider end incorporating the digital content, the real-time multi-dimensions timestamp, and the multi-dimensions geographic information together as a reliable digital content.

11. The method as claimed in claim 10, wherein the multi-dimensions geographic information comprises at least one or the combination above two of a latitude, a longitude, or an altitude.

12. The method as claimed in claim 10, wherein the multi-dimensions timestamp device providing a real-time machine time as the real-time multi-dimensions timestamp, the real-time machine time is accurate to the minimum time unit the multi-dimensions timestamp device can display.

13. The method as claimed in claim 12, wherein the multi-dimensions timestamp device comprising a multi-dimensions timestamp generator to apply a present time of a timer as the real-time machine time.

14. The method as claimed in claim 12, wherein the real-time multi-dimensions timestamp further includes longitude, latitude, or both.

15. An authentication system of synchronizing real-time multi-dimensions timestamp issued by a multi-dimensions timestamp device, comprising:
a multi-dimensions timestamp device being configured to provide a real-time machine time, the real-time machine time is accurate to the minimum time unit the multi-dimensions timestamp device can present;
a provider end being configured to use the multi-dimensions timestamp device to implant a real-time multi-dimensions timestamp into a digital content, the provider end receives a multi-dimensions geographic information from a multi-dimensions geographic information provider, the provider end provides a network location information, and incorporates the digital content, the real-time multi-dimensions timestamp, the network location information, and the multi-dimensions geographic information together as a reliable digital content; and
a receiver end being configured to receive the reliable digital content from a arbitrary party end, wherein the receiver end retrieves the real-time multi-dimensions timestamp, the network location information, and the multi-dimensions geographic information from the reliable digital content, and is connected to the provider end via network according to the network location information to confirm whether the provider end has the identical reliable digital content, the real-time multi-dimensions timestamp, and the multi-dimensions geographic information, when the received reliable digital content in the receiver end is confirmed to have the identical reliable digital content, the real-time multi-dimensions timestamp, and the multi-dimensions geographic information, the receiver end confirms the reliable digital content from the arbitrary party end is genuine.

16. The system as claimed in claim 15, wherein the receiver end further includes a verifying information, the verifying information is set in the receiver end to verify whether the reliable digital content matches with the verifying information.

17. The system as claimed in claim 15, wherein the multi-dimensions geographic information comprises at least one or the combination above two of a latitude, a longitude, or an altitude.
